(19) United States
(12) Patent Application Publication
(10) Pub. No.: US 2017/0241715 A1
(43) Pub. Date: Aug. 24, 2017

(54) HEAT EXCHANGE DEVICE AND MANUFACTURING METHOD OF HEAT EXCHANGE DEVICE

(71) Applicant: DENSO CORPORATION, Kariya-city, Aichi-pref. (JP)

(72) Inventors: Aun OTA, Kariya-city (JP); Shinichiro NAKAMURA, Kariya-city (JP); Hisayoshi OSHIMA, Kariya-city (JP)

(21) Appl. No.: 15/519,494

(22) PCT Filed: Nov. 4, 2015
(86) PCT No.: PCT/JP2015/005523

§ 371 Date: Apr. 14, 2017

(30) Foreign Application Priority Data
Nov. 11, 2014 (JP) 2014-229155

(51) Int. Cl. F28D 7/00; F28F 21/02; F28F 9/02; B23P 15/26; F28F 1/12

(52) U.S. Cl. CPC F28D 7/0066; B23P 15/26; F28F 1/12; F28F 9/02; F28F 21/02

(57) ABSTRACT

A heat exchange device has a heat transfer member having thermal conductivity and a fin that is provided integrally with the heat transfer member. A heat transfer is performed between the heat transfer member and the fin. The fin is configured by more than one of a carbon nanotube aggregate that is configured by carbon nanotubes assembled together. The carbon nanotube aggregates are arranged on the heat transfer member and distanced from each other, and protrude from the heat transfer member in an axial direction of the carbon nanotubes.

### CROSS REFERENCE TO RELATED APPLICATION

This application is based on Japanese Patent Application No. 2014-229155 filed on Nov. 11, 2014, the disclosure of which is incorporated herein by reference.

### TECHNICAL FIELD

The present disclosure relates to a heat exchanger that has a fin increasing a surface area of a heat transfer member generating or absorbing heat, and relates to a method thereof.

### BACKGROUND ART

A heat exchanger described in Patent Literature 1 has tubes and a fin having a corrugated shape. The tubes are arranged parallel to each other and distanced from each other. The tubes have a side portion through which a cooling air flows, and the side portion has a specified thickness. The fin is arranged between adjacent two of the tubes such that the fin and the adjacent two of the tubes are stacked to be specified distance away from each other. The fin causes a fluid flowing through the tubes to radiate heat. A heat radiation performance of the fin can be improved by improving fin efficiency in a manner that a thickness of the fin is increased or that a height dimension of the fin is decreased.

Alternatively, a fin having a small thickness may be used to improve the heat radiation performance and to reduce a flow resistance of the fluid. However, a realistic value of the thickness is about 50 μm when the fin is made of aluminum, in terms of securing the fin efficiency and process limitation of a material. The fin efficiency is a ratio of an amount of heat, which is actually radiated from the fin, with respect to an ideal amount of heat radiated from the fin. The ideal amount is a heat transfer amount when estimating a surface temperature of the fin to be equal to a temperature of base portions of the fin.

Conventionally, a material making the fin is considered to have high thermal conductivity to improve the fin efficiency. Patent Literature 2 discloses a heat exchange device a heat radiation fin that is made of a metal plate to have a corrugated shape. A graphite sheet made of a graphite treated polymer film is attached to a surface of the metal plate.

### PRIOR ART LITERATURES

### Patent Literature

Patent Literature 1: JP 2001-050678 A

Patent Literature 2: JP 3649150 B

### SUMMARY OF INVENTION

According to the heat exchange device that has the fin having the corrugated shape as in Patent Literature 1, a height dimension of the fin from a base heat transfer surface is required to be small to secure the fin efficiency in a case of decreasing a thickness of the fin. The heat exchange device is downsized by decreasing the height dimension of the fin. On the other hand, when the height dimension of the fin is set small, a heat transfer surface area may not be secured since a surface area of the fin cannot be increased. The heat radiation performance may deteriorate due to a deterioration of the fin efficiency when the thickness of the fin is decreased while maintaining the height dimension of the fine to secure the heat transferring surface area. In addition, the process limitation for manufacturing the fin should be considered when decreasing the thickness of the fin, and thereby the thickness is required to be set above a certain level for maintaining a shape of the fin.

The heat exchange device disclosed in Patent Literature 2 can provide a heat radiation fin of which fin efficiency is greater than a molded metal plate having a corrugated shape. However, the heat exchange device cannot sufficiently fulfill a requirement to achieve both of downsizing of the heat exchange device and improving a heat exchanging performance.

The present disclosure addresses the above issues, and it is an objective of the present disclosure to provide a heat exchange device that can achieve both increasing a heat transfer surface area in a unit volume and downsizing the heat exchange device, and to provide a manufacturing method of the heat exchanger.

A heat exchange device has a heat transfer member having thermal conductivity and a fin provided integrally with the heat transfer member. A heat transfer is performed between the heat transfer member and the fin. The fin is configured by more than one of a carbon nanotube aggregate that is configured by carbon nanotubes assembled together. The carbon nanotube aggregates are arranged on the heat transfer member and distanced from each other. The carbon nanotube aggregates protrude from the heat transfer member in an axial direction of the carbon nanotubes.

According to the present disclosure, the carbon nanotube aggregates, of which diameter is larger than or equal to a nano size, are provided in a surface of the heat transfer member to be distanced from each other. Since the carbon nanotube aggregates are distanced from each other and protrude toward the heat transfer member, a fluid can flow between the carbon nanotube aggregates, and a surface area of the carbon nanotube aggregates becomes a heat transfer surface area in which a heat transfer is performed. The carbon nanotube aggregates are extremely thin. Accordingly, the carbon nanotube aggregates protruding from the heat transfer member in the axial direction can increase the heat transfer surface area greatly in a unit volume as compared to a fin having a corrugated shape. In addition, the carbon nanotube aggregates can secure great fin efficiency even in a case that the carbon nanotube aggregates have an extremely thin fin shape of which size is a micron scale, since carbon nanotube has a great thermal conductivity that is seven to ten times as large as that of aluminum. As a result, the heat transfer surface area that is effective for high fin efficiency can be increased, and thereby a volume of the heat exchange device can be decreased. Thus, the heat exchange device that can achieve both increasing the heat transfer surface area in a unit volume and downsizing the heat exchange device is provided.

A manufacturing method of a heat exchange device according to the present disclosure includes arranging catalysts distanced from each other on a surface of a heat transfer member having thermal conductivity to set locations in which the catalysts are located, and heating the heat transfer member, the locations in which are set, in a furnace in a presence of methane or acetylene gas after locating the heat transfer member inside the furnace.

According to the present disclosure, the carbon nanotube aggregates grow from the locations, in which the catalysts are located, in the heating. The carbon nanotube aggregates grow and extend from the locations provided in the surface of the heat transfer member. That is, the carbon nanotube aggregates can be provided to protrude from the heat transfer member by heating the heat transfer member in a presence of methane or acetylene gas. Thus, according to the present disclosure, the heat exchange device in which the carbon nanotube aggregates are provided to protrude from the surface of the heat transfer member and to be distanced from each other can be provided. The heat exchange device can achieve both increasing the heat transfer surface area in a unit volume and downsizing the heat exchange device.

Alternatively, according to a manufacturing method of a heat exchange device according to the present disclosure may include arranging catalysts distanced from each other on a surface of a tube, which has thermal conductivity and covered with a brazing material, to set locations in which the catalysts are located, assembling more than one of the tube, the locations in which are set, with a header tank to be an assembled body such that the tubes are distanced from each other in the assembled body, and heating the assembled body in a furnace in a presence of methane or acetylene gas, after locating the assembled body inside the furnace.

The carbon nano tube aggregates grow from the locations, in which the catalysts are located, in the heating. The carbon nanotube aggregates grow and extend from the locations provided in a surface of the tube. That is, the carbon nanotube aggregates protruding from the surface of the tube toward an adjacent tube can be provided at the same time of brazing, by performing a furnace brazing in which the tube and the header tank are brazed with each other in the furnace. Thus, according to the present disclosure, the heat exchange device having the carbon nanotube aggregates provided between adjacent two tubes of the tubes can be provided. The heat exchange device can achieve both increasing the heat transfer surface area in a unit volume and downsizing the heat exchange device.

### BRIEF DESCRIPTION OF DRAWINGS

The above and other objects, features and advantages of the present disclosure will become more apparent from the following detailed description made with reference to the accompanying drawings.

FIG. 1 is a perspective view illustrating a heat exchange device according to a first embodiment.

FIG. 2 is a partial cross-sectional view illustrating a configuration of a tube and a fin in the heat exchanger according to the first embodiment.

FIG. 3 is a perspective view illustrating the configuration of the tube and the fin according to the first embodiment.

FIG. 4 is a chart illustrating a manufacturing process of the heat exchange device according to the first embodiment.

FIG. 5 is a perspective view illustrating a state after arranging catalysts.

FIG. 6 is a perspective view illustrating a state in which carbon nanotube aggregates are growing in a furnace brazing.

FIG. 7 is a front view illustrating a state after the furnace brazing.

FIG. 8 is a perspective view illustrating a configuration of a tube and a fin according to a second embodiment.

FIG. 9 is a perspective view illustrating a configuration of a tube and a fin according to a third embodiment.

### DESCRIPTION OF EMBODIMENTS

Embodiments of the present disclosure will be described hereinafter referring to drawings. In the embodiments, a part that corresponds to or equivalents to a matter described in a preceding embodiment may be assigned with the same reference number, and descriptions of the part may be omitted. When only a part of a configuration is described in an embodiment, parts described in preceding embodiments may be applied to the other parts of the configuration. The parts may be combined even if it is not explicitly described that the parts can be combined. The embodiments may be partially combined even if it is not explicitly described that the embodiments can be combined, provided there is no harm in the combination.

A heat exchange device according to the present disclosure has a fin that increases a surface area of a heat transfer member. The heat transfer member generates heat or absorbs heat. The heat exchange device includes the following heat exchange device for example. A heat exchange device has a heat transfer member and a fin provided integrally with the heat transfer member. The heat transfer member is a heat generating body or a body thermally connected with a heat generating body. Accordingly, heat generated by the heat generating body transfers from the heat transfer member to the fin, and further transfers from the fin to a fluid flowing around the fin. As a result, the heat generating body is cooled. Alternatively, a heat exchange device has a tube in which a heat medium flows and a fin provided integrally with the tube. Heat of the heat medium transfers from the tube to the fin, and further transfers from the fin to a fluid flowing around the fin. As a result, the heat medium is cooled.

### First Embodiment

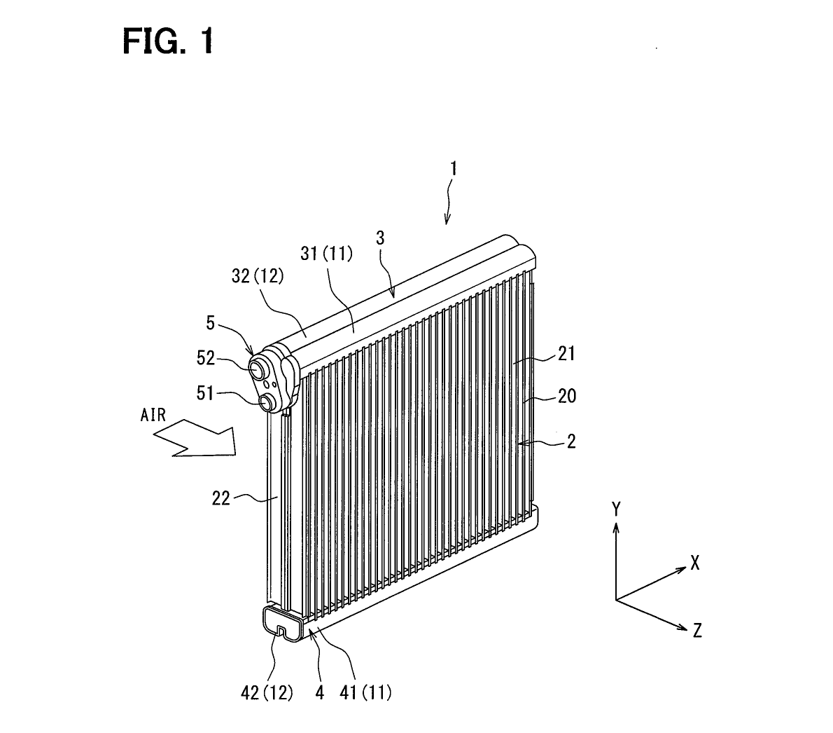

A first embodiment, as one embodiment of the present disclosure, will be described hereafter referring to FIG. 1 through FIG. 7. For example, a heat exchange device 1 is a component mounted in a refrigeration cycle for a vehicle air conditioner. The heat exchange device 1 is used as, for example, a evaporator that evaporates a refrigerant. The refrigerant is compressed in a compressor to have a high temperature and a high pressure, radiates heat and is cooled in a radiator, decompressed in a decompressor to have a low temperature and a low pressure, and then flows into the evaporator. The heat exchanger device 1 alternatively used as, for example, a radiator that cools the refrigerant, which is compressed to have a high temperature and a high pressure in the compressor, by causing the refrigerant to radiate heat, or a condenser that condenses the refrigerant.

The refrigerant is carbon dioxide (CO₂) having a low critical temperature in a case that the heat exchange device 1 is provided in a supercritical heat pump cycle in which a refrigerant pressure on a high pressure side becomes greater than a critical pressure of the refrigerant. The refrigerant flowing in the heat exchange device 1 is not limited to carbon dioxide and may be another refrigerant such as chlorofluorocarbon.

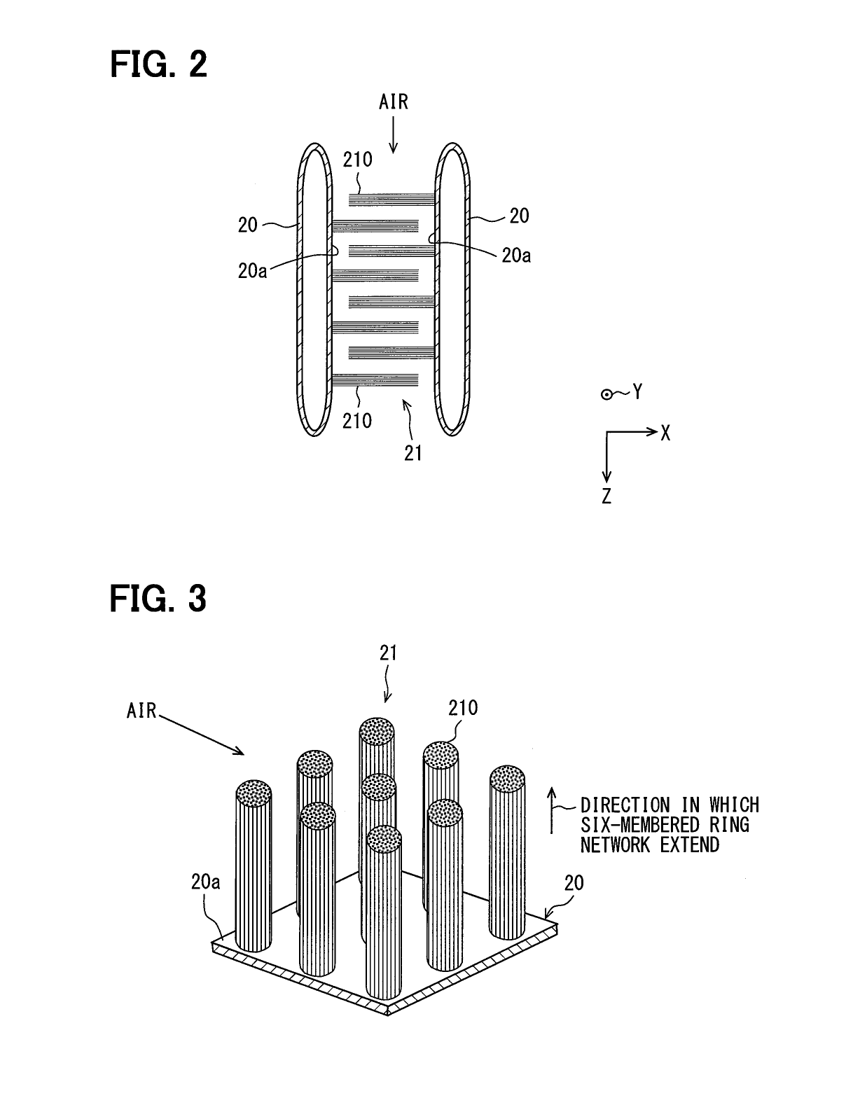

The heat exchange device 1 has, for example, a configuration shown in FIG. 1. The heat exchange device 1 has a heat exchange core 2, an upper header tank 3, and a lower header tank 4. The heat exchange core 2 has tubes 20, fins 21, and a side plate 22. The tubes 20 and the fins 21 are stacked alternately with each other in a stacking direction, and the side plate is located on an exterior side of an outermost fin 21 that is located at an outermost end of the fins 21 in the stacking direction. The fins 21 are a heat exchange fin that increases a heat transfer surface area in which a heat transfer is performed. In FIG. 1 and FIG. 2, the tubes 20 are arranged in a direction X, air flows in a direction Z, and a direction Y is a longitudinal direction of the tubes 20 and indicates upward in a vertical direction.

The heat exchange core 2 has more than one of a series of the tubes 20, each of which extends in the vertical direction, arranged in a lateral direction. An upstream series of the tubes 20 is located at an upstream end of the heat exchange core 2 in a flow direction of air that is an external fluid exchanging heat with the refrigerant, and a downstream series of the tubes 20 is located at a downstream end of the heat exchange core 2 in the flow direction. That is, at least two series of the tubes 20 are located adjacent to each other in the flow direction of air. The tubes 20 are a tubular member configured by a strip-shaped thin plate made of a material such as aluminum or an aluminum alloy. The strip-shaped thin plate is bent to have a tubular shape that is flat in a cross section perpendicular to the longitudinal direction. The longitudinal direction coincides with a flow direction of an internal fluid. For example, an inner fin is connected inside the tube 20.

The side plate 22 is a reinforcement member of the heat exchange core 2 and is configured by a flat plate made of a material such as aluminum or an aluminum alloy by pressing. The side plate 22 has an end portion in the longitudinal direction having a flat shape. The other portion of the side plate 22 has a generally U-shape that is open to an outside of the heat exchange core 2 in the stacking direction in which the tubes 20 and the fin 21 are stacked. The side plate 22 may have a fin 21 that protrudes toward an adjacent tube 20.

The downstream series of the tubes 20 is coupled with a downstream header tank 11. The downstream header tank 11 has a downstream upper tank 31 joined with an upper end of the downstream series of the tubes 20 and a downstream lower tank 41 joined with a lower end of the downstream series of the tubes 20. The downstream header tank 11 is a chamber that collects refrigerant flowing from an inside of the downstream series of the tubes 20 and that distributes the refrigerant to an inside of the downstream series of the tubes 20.

The downstream upper tank 31 has a left end portion in the lateral direction (i.e., an end portion in a direction opposite to the direction X), and the left end portion is coupled with a connector 5 having a block shape by brazing. The connector 5 has an inlet 51 as a refrigerant inlet. The inlet 51 communicates with an inside of the downstream header tank 11 and guides the refrigerant into the heat exchange core 2.

The upstream series of the tubes 20 is coupled with an upstream header tank 12. The upstream header tank has an upstream upper tank 32 joined with an upper end of the upstream series of the tubes 20 and an upstream lower tank 42 joined with a lower end of the upstream series of the tubes 20. The upstream header tank 12 is a chamber that collects refrigerant flowing from an inside of the upstream series of the tubes 20 and that distributes the refrigerant to an inside of the upstream series of the tubes 20.

The connector 5 has an outlet 52 as a refrigerant outlet. The outlet 52 communicates with an inside of the upstream header tank 12 and guides the refrigerant to flow from the inside of the heat exchange core 2 to an external component. The inlet 51 and the outlet 52 are provided with end portions of the downstream header tank 11 and the upstream header tank 12 respectively on the same side in the lateral direction.

The upper header tank 3 is divided, in the longitudinal direction, into to a tank header located on a side opposite from the tubes 20 and a plate header located on a side adjacent to the tubes 20. The upper header tank 3 has a cap, the downstream upper tank 31, and the upstream upper tank 32. The tank header and the plate header respectively have a cross-sectional shape that is provided by two semicircles or two rectangles coupled with each other. The tank header and the plate header are configured by a flat plate made of aluminum and are formed by pressing. The tank header and the plate header are fitted together and brazed with each other, and thereby a tubular body in which two interior spaces are arranged in the flow direction of air is provided. The cap is brazed to each openings of the downstream upper tank 31 and the upstream upper tank 32 located at both ends in a longitudinal direction of the tubular body, such that the openings are sealed by the cap. The cap is configured by a flat plate made of aluminum and is formed by pressing.

Similar to the upper header tank 3, the lower header tank 4 has a cap, the downstream lower tank 41, and the upstream lower tank 42. The lower header tank 4 is a tubular body having a tank header and a plate header, and the cap is provided to each opening of the tubular body located at both ends of the longitudinal direction of the tubular body.

The upper header tank 3 and the lower header tank 4 have a wall surface adjacent to the heat exchange core 2. The wall surface is provided with tube insertion holes and side plate insertion holes that are arranged at regular intervals in the longitudinal direction of the header tanks 3, 4. The tube insertion holes and end portions of the tubes 20 in the longitudinal direction of the tubes are brazed with each other on a condition that the end portions of the tubes 20 are inserted to the tube insertion holes. The side plate insertion holes and end portions of the side plates 22 in the longitudinal direction of the tubes are brazed with each other on a condition that the end portions of the side plates 22 are inserted to the side plate insertion holes. As a result, the tubes 20 communicate with the interior spaces of the upper header tank 3 and the lower header tank 4. End portions of the side plate 22 in the longitudinal direction of the tubes are supported by the upper header tank 3 and the lower header tank 4 respectively.

As shown in FIG. 2, the tubes 20 have fins 21 integrally provided with the tubes 20 respectively. As shown in FIG. 2 and FIG. 3, each of the fins 21 is configured by more than one of a carbon nanotube aggregate (hereinafter referred to as a CNT aggregate 210) that is configured by carbon nanotubes assembled together. The carbon nanotubes configuring the CNT aggregate 210 have a diameter of a few nanometers to a few dozen nanometers and are assembled by van der Waals force. A shape of the CNT aggregate 210 is retained by van der Waals force. The CNT aggregate 210 is configured by the carbon nanotubes assembled in a bunch. The more than one of the CNT aggregate 210 are arranged on a flat portion 20a of the tubes 20 and distanced from each other.

The CNT aggregates 210 are provided between adjacent two tubes 20. The CNT aggregates 210 protrude from the flat portion 20a of one of the adjacent two tubes 20 toward the flat portion 20a of the other one of the adjacent two tubes 20 in an axial direction (i.e., a longitudinal direction) of the carbon nanotubes, and protrude from the flat portion 20a of the other one of the adjacent two tubes 20 toward the flat portion 20a of the one of the adjacent two tubes 20 in the axial direction. The CNT aggregates 210 are a forest of CNT aggregates 210 protruding from the flat portion 20a. A fluid such as air flows around the forest of CNT aggregates 210 and exchanges heat with the CNT aggregates 210. As a result, the fluid is cooled or heated. According to the above-described configuration, the forest of the CNT aggregates 210 provided between adjacent two of the tubes functions as a fin that increases a heat transfer surface area of the heat transfer member generating or absorbing heat. As shown in FIG. 2 and FIG. 3, the CNT aggregates 210 protrude from the heat transfer member (i.e., the tubes 20) in a direction perpendicular to the flow direction of the fluid (i.e., air) flowing around the CNT aggregates 210.

In other words, as shown in FIG. 2, the heat transfer member (i.e., the tubes 20) includes a first heat transfer portion and a second heat transfer portion. The first heat transfer portion has more than one of the CNT aggregate 210 protruding from the first heat transfer portion toward the second heat transfer portion. The second heat transfer portion has more than one of the CNT aggregate 210 protruding from the second heat transfer portion toward the first heat transfer portion. A part of the CNT aggregates 210, which protrude from the first heat transfer portion, and a part of the CNT aggregates 210, which protrude from the second heat transfer portion, are overlap with each other in the flow direction of the fluid flowing around the CNT aggregates 210.

A protruding dimension of the CNT aggregates 210 protruding from the heat transfer member in the axial direction of the carbon nanotubes is greater than a distance between adjacent two of the CNT aggregates 210 on the heat transfer member

The tubes 20 are an example of the heat transfer member generating or absorbing heat. The tubes 20 radiate heat outward in a case that a high-pressure refrigerant flows in the tubes 20. In this case, the refrigerant as the heat medium is cooled in a manner that heat of the refrigerant transfers from the tubes 20 to the CNT aggregates 210 and further transfers from the CNT aggregates 210 to the fluid such as air flowing around the CNT aggregates 210. The tubes 20 absorb heat in a case that a refrigerant after being decompressed flows in the tubes 20. In this case, the refrigerant flowing in the tubes 20 absorb heat of the fluid such as air flowing around the CNT aggregates 210, in a manner that the heat of the fluid transfers to the CNT aggregates 210 and further transfers from the CNT aggregates 210 to the tubes 20.

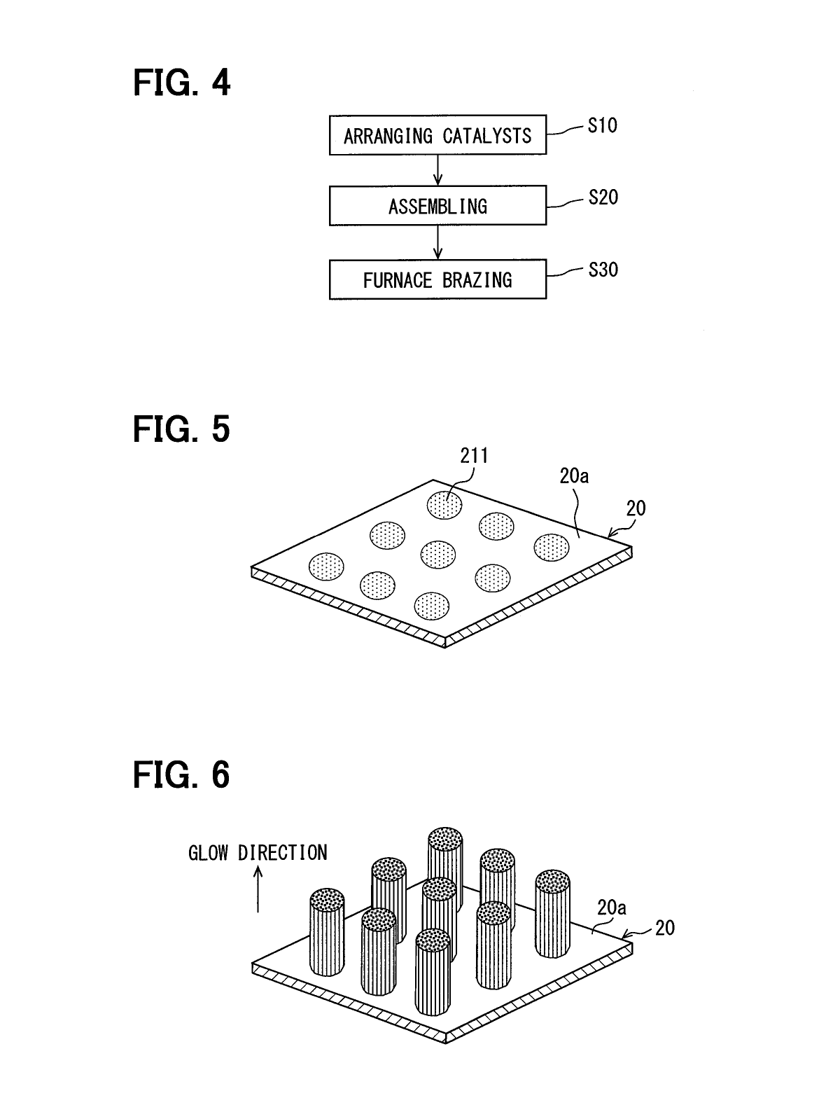

A manufacturing method of the heat exchange device will be described hereafter referring to FIG. 4 through FIG. 7. The manufacturing method includes arranging catalysts (S10), assembling (S20), and furnace brazing (S30). In the arranging catalysts, catalysts are arranged to be distanced from each other in the flat portion 20a that is a surface of the tubes 20. That is, locations 211 in which the catalysts are located are set on the flat portion 20a. The locations 211 correspond to base portions of the CNT aggregates 210 configuring the fin 21. For example, the CNT aggregates 210 having a columnar shape protrude from the locations 211 respectively when the catalysts are located to have a circular shape on the flat portion 20a as shown in FIG. 5.

In the assembling, the tubes 20 are inserted to the tube insertion holes of the upper header tank 3 and the lower header tank 4, and the side plates 22 and the cap are assembled. The heat exchange device 1 is assembled to be an assembled body having a product shape in the assembling. In the furnace brazing, specified portions are supported to suppress a deformation of the product shape and suppress a misalignment of components. The tubes 20, the side plates 22, and the cap are covered with a brazing material in advance for being brazed in the furnace brazing. That is, a clad member cladding the brazing material is used as those members.

The furnace brazing is, i.e., heating, that is a process to heat the assembled body in a furnace in a presence of methane or acetylene gas, after locating the assembled body inside the furnace. That is, the carbon nanotubes grow by pyrolysis of hydrocarbon such as methane or acetylene gas with nanoparticles that is a catalytic metal. A heating temperature is set to be a temperature (e.g., 580-600° C.) at which the brazing material melts, and a heating duration is, e.g., 20-30 minutes. In the heating, the brazing material melts in each connection portion between the members, and thereby the members are brazed with each other. As a result, the CNT aggregates 210 are provided. In the furnace brazing, as shown in FIG. 6, the carbon nanotubes gradually grow to protrude from the locations 211 in the flat portion 20a. The carbon nanotubes keep growing during the heating, and a height of the carbon nanotubes reaches a specified height shown in FIG. 7. At this time, a reaction between Al203 and carbon in the gas is caused, and aluminum carbide (Al4C3) is provided in base portions 210a. The base portions 210a covered with aluminum carbide support the CNT aggregates 210 respectively. That is, the base portions 210a function as reinforcements.

The above-described process flow is a manufacturing method using CVD method. The heat exchange device 1 having the tubes 20 in which the forest of the CNT aggregates 210 are provided can be manufactured by the above-described process flow. According to the manufacturing method, CNT aggregates 210 protrude from the tubes 20 in a direction in which a six-membered ring network extends. The six-membered ring network is made of carbon and configures the carbon nanotubes.

Next, operation effects provided by the heat exchange device according to the first embodiment will be described hereafter. The heat exchange device has a heat transfer member having thermal conductivity and a fin 21 that is provided integrally with the heat transfer member. A heat transfer is performed between the heat transfer member and the fin. The fin is configured by more than one of a carbon nanotube aggregate that is configured by carbon nanotubes assembled together. The carbon nanotube aggregates are arranged on the heat transfer member and distanced from each other. The carbon nanotube aggregates protrudes from the heat transfer member in an axial direction of the carbon nanotubes.

Accordingly, the carbon nanotube aggregates having a diameter of a nano size order is provided on a surface of the heat transfer member to be distanced from each other. Since the carbon nanotube aggregates 210 protrude from the heat transfer member and are distanced from each other, a fluid can flow around a forest of the carbon nanotube aggregates, and a surface area of the carbon nanotube aggregates 210 becomes a heat transfer surface area in which a heat transfer is performed. The CNT aggregates 210 are extremely thin. Accordingly, the forest of the CNT aggregates 210 protruding from the transfer member in the axial direction can greatly increase the heat transfer surface area in a unit volume as compared to a conventional corrugated fin. As a result, a volume for providing a required heat transfer surface area can be decreased. In addition, a carbon nanotube has great thermal conductivity, and thereby a temperature difference between a temperature of a tip portion and a temperature of a bottom portion in the CNT aggregate 210 is small. Therefore, the fin 21 configured by the CNT aggregates 210 can have great fin efficiency and a high heat exchange performance. Thus, according to the heat exchange device of the first embodiment can achieve both of increasing the heat transfer surface area in a unit volume and downsizing the heat exchange device.

The CNT aggregates 210 protrude from the heat transfer member in the direction in which the six-membered ring network extends. The six-membered ring network is made of carbon and configures the carbon nanotubes. According to the configuration, the six-membered ring network extends in the axial direction of the carbon nanotubes, and thereby heat conductivity can be improved in the longitudinal direction of the carbon nanotubes. As a result, a temperature gradient between the tip portion and the bottom portion in the CNT aggregate 210 is small, and the fin efficiency of the fin 21 can be improved.

The CNT aggregates 210 protrude from the heat transfer member in the direction perpendicular to the flow direction of the fluid flowing around the CNT aggregates 210. According to the configuration, the fluid flows smoothly around the CNT aggregates 210. In addition, the CNT aggregates 210 as the fin can be arranged effectively, and thereby the heat transfer surface area can be increased.

The heat transfer member is the tubes 20 in which refrigerant flows and which are stacked and distanced from each other. The CNT aggregates 210 are provided on the surface (i.e., the flat portion 20a) of each tube 20. The CNT aggregates 210 are distanced from each other and protrude toward the adjacent tube 20. According to the configuration, a fin configuration, in which the heat transfer surface area in a unit volume can be increased greatly as compared to a conventional corrugated fin, can be provided. As a result, the volume for providing the required heat transfer surface area can be small. Thus, the heat exchange device that can downsize the heat exchange core 2 having a configuration in which the tubes 20 and the fins 21 are stacked alternately with each other can be provided.

Alternatively, the heat transfer member is a heat generating member that generates heat outward. The CNT aggregates 210 are provided between surfaces of the heat generating members that are heat generating bodies and protrude from the heat generating bodies in the axial direction of the carbon nanotubes. According to the configuration, a configuration for a heat radiation fin that can greatly increase the heat transfer surface area in a unit volume can be provided. Thus, an effective heat radiation can be performed with a small volume, and a heat radiation device (e.g., a heat sink) that can achieve both improving a heat radiation performance and downsizing the heat radiation device can be provided.

A manufacturing method of the heat exchange device includes, for example, arranging catalysts, assembling, and heating. The arranging is a process in which the catalysts are arranged on a surface (i.e., the flat portion 20a) of the tube 20 to be distanced from each other, such that the locations, in which the catalysts are located, are set. The tubes 20 have thermal conductivity and are covered with a brazing material. The assembling is a process in which more than one of the tube 20, the locations in which are set, is assembled with the upper header tank 3 and the lower header tank 4 to be an assembled body. The tubes 20 are distanced from each other in the assembled body. The heating is a process in which the assembled body is heated in a furnace in a presence of methane or acetylene gas, after locating the assembled body inside the furnace.

According to the manufacturing method, the carbon nanotube aggregates grow from the locations in the heating. The CNT aggregates 210 grow to protrude from the locations provided in the surface of the tubes 20. That is, the CNT aggregates 210 protruding from the surface of one tube 20 toward an adjacent tube 20 can be provided at the same time of performing the furnace brazing in which the tubes 20 and each of the upper header tank 3 and the lower header tank 4 are brazed with each other. Accordingly, the heat exchange device 1 having the CNT aggregates 210 located between adjacent two tubes of the tubes 20 can be provided.

Alternatively, the heat exchange device can be manufactured by the following method. A manufacturing method includes arranging catalysts and heating. The arranging is a process in which the catalysts are arranged on a surface of the heat transfer member having thermal conductivity to be distanced from each other, such that locations, in which the catalysts are located, are set. The heating is a process in which the heat transfer member, the location of which are set, is heated in a furnace in a presence of methane or acetylene gas, after locating the heat transfer body inside the furnace.

According to the manufacturing method, the carbon nanotube aggregates grow from the locations in the heating. The CNT aggregates 210 grow to protrude from the locations provided in the surface of the heat transfer member. That is, the CNT aggregates 210 distanced from each other can be provided to protrude from the heat transfer member other than the tubes 20 by heating the heat transfer member in a presence of methane or acetylene gas.

### Second Embodiment

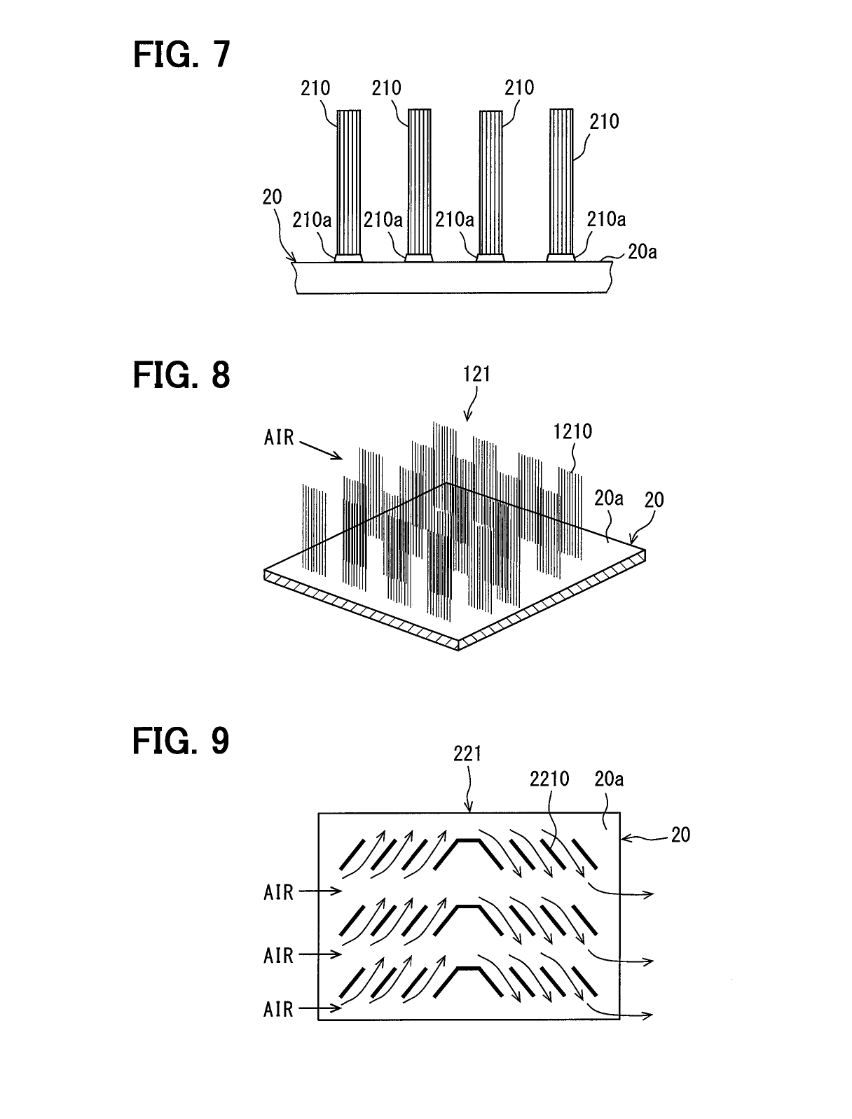

According to a second embodiment, a fin 121 that is another example of the fin 21 of the first embodiment will be described referring to FIG. 8.

As shown in FIG. 8, the fin 121 is configured by more than one of a CNT aggregate 1210 that is configured by carbon nanotube assembled together. The carbon nanotubes configuring the CNT aggregate 1210 have a diameter of a few nanometers to a few dozen nanometers and are assembled by van der Waals force to have a thin plate shape. The thin plate shape of the CNT aggregate 1210 is retained by van der Waals force. The CNT aggregate 1210 is configured by the carbon nanotubes assembled in a bunch. The more than one of the CNT aggregate 210 are arranged on the flat portion 20a of the tubes 20 and distanced from each other.

A forest of the CNT aggregates 1210 protrude from the flat portion 20a. A fluid such as air flows around the CNT aggregates 1210 along a surface of the CNT aggregates 1210 forming the thin plate. According to the configuration, the fluid flows around the CNT aggregates 1210 while receiving a small flow resistance. The CNT aggregates 1210 protrude from the heat transfer member (i.e., the tubes 20) in a direction in which a six-membered ring network extends. The six-membered ring network is made of carbon and configures the carbon nanotubes.

### Third Embodiment

According to a third embodiment, a fin 221 that is another example of the fin 21 of the first embodiment will be described referring to FIG. 9.

As shown in FIG. 9, the fin 221 is configured by more than one of a CNT aggregate 2210 that is configured by carbon nanotube assembled together. The carbon nanotubes configuring the CNT aggregate 2210 have a diameter of a few nanometers to a few dozen nanometers and are assembled by van der Waals force to have a thin plate shape. The thin plate shape of the CNT aggregate 1210 is retained by van der Waals force. The CNT aggregates 2210 configuring the fin 221 are arranged such that a fluid flows on the heat transfer member (i.e., the tubes 20) along a serpentine course in a planar view. According to the configuration, a flow of the fluid is disturbed on the heat transfer member, and the fluid flows in a state of turbulent flow rather than a state of laminar flow. Accordingly, the heat exchange device that can achieve increasing the heat transfer surface area, improving the fin efficiency, and improving a heat exchange performance by the turbulent flow at the same time can be provided.

(Other Modifications)

While the present disclosure has been described with reference to preferred embodiments thereof, it is to be understood that the disclosure is not limited to the preferred embodiments and constructions. The present disclosure is intended to cover various modification and equivalent arrangements within a scope of the present disclosure. It should be understood that structures described in the above-described embodiments are preferred structures, and the present disclosure is not limited to have the preferred structures. The present disclosure is intended to cover various modifications and equivalent arrangements within the scope of the present disclosure.

The heat transfer member integrally provided with more than one of a CNT aggregate is not limited to be made of aluminum. The heat transfer member may be made by the above-described manufacturing method with a material other than metal as long as the material enables the CNT aggregate to grow.

What is claimed is:

1. A heat exchange device comprising:
a heat transfer member having thermal conductivity; and
a fin that is provided integrally with the heat transfer member, a heat transfer being performed between the heat transfer member and the fin, wherein
the fin is configured by more than one of a carbon nanotube aggregate that is configured by carbon nanotubes assembled together, and
the carbon nanotube aggregates are arranged on the heat transfer member and distanced from each other, the carbon nanotube aggregates protruding from the heat transfer member in an axial direction of the carbon nanotubes.

2. The heat exchange device according to claim 1, wherein
the carbon nanotube aggregates protrude from the heat transfer member in a direction in which a six-membered ring network extends, the six-membered ring network being made of carbon and configuring the carbon nanotubes.

3. The heat exchange device according to claim 1, wherein
the carbon nanotube aggregates protrude from the heat transfer member in a direction perpendicular to a flow direction of a fluid flowing around the carbon nanotube aggregates.

4. The heat exchange device according to claim 1, wherein
the heat transfer member is a plurality of tubes in which refrigerant flows, the plurality of tubes being stacked and distanced from each other,
the plurality of tubes respectively have surfaces that are provided with the carbon nanotube aggregates, the carbon nanotube aggregates being distanced from each other and protruding toward an adjacent tube of the plurality of tubes.

5. The heat exchange device according to claim 1, wherein
the heat transfer member is a heat generating member that generates heat outward,
the carbon nanotube aggregates are arranged on a surface of the heat generating member, the carbon nanotube aggregates being distanced from each other and protruding from the heat generating member in an axial direction of the carbon nanotubes.

6. The heat exchange device according to claim 1, wherein
a fluid flows around the carbon nanotube aggregates.

7. The heat exchange device according to claim 1, wherein
the heat transfer member includes a first heat transfer portion and a second heat transfer portion facing each other,
the first heat transfer portion has the carbon nanotube aggregates protruding from the first heat transfer portion toward the second heat transfer portion,
the second heat transfer portion has the carbon nanotube aggregates protruding from the second heat transfer portion toward the first heat transfer portion,
a part of the carbon nanotube aggregates, which protrude from the first heat transfer portion, and a part of the carbon nanotube aggregates, which protrude from the second heat transfer portion, are overlap with each other in a flow direction of a fluid flowing around the carbon nanotube aggregates.

8. The heat exchange device according to claim 1, wherein
a protruding dimension of the carbon nanotube aggregates protruding from the heat transfer member in an axial direction of the carbon nanotubes is greater than a distance between adjacent two of the carbon nanotube aggregates on the heat transfer member.

9. A manufacturing method of a heat exchange device, comprising:
arranging a plurality of catalysts distanced from each other on a surface of a heat transfer member to set locations in which the plurality of catalysts are located, the heat transfer member having thermal conductivity; and
heating the heat transfer member, the locations in which are set, in a furnace in a presence of methane or acetylene gas, after locating the heat transfer member inside the furnace.

10. A manufacturing method of a heat exchange device, comprising:
arranging a plurality of catalysts distanced from each other on a surface of a tube to set locations in which the plurality of catalysts are located, the tube having thermal conductivity and covered with a brazing material;
assembling more than one of the tube, the locations in which are set, with a header tank to be an assembled body, the tubes being distanced from each other in the assembled body; and
heating the assembled body in a furnace in a presence of methane or acetylene gas, after locating the assembled body inside the furnace.
